(19) United States
(12) Patent Application Publication
(10) Pub. No.: US 2021/0360879 A1
(43) Pub. Date: Nov. 25, 2021

(54) HYDRAULIC ACTUATOR, WORKING DEVICE, AND ENERGY-WOOD GRAPPLE

(71) Applicant: TMK Energiakoura Oy, SÄKINMÄKI (FI)

(72) Inventors: Tenho Koponen, SÄKINMÄKI (FI); Mika Koponen, HYVINKÄÄ (FI)

(21) Appl. No.: 17/045,244

(22) PCT Filed: Apr. 8, 2019
(86) PCT No.: PCT/FI2019/050287

§ 371 Date: Oct. 5, 2020

(30) Foreign Application Priority Data
Apr. 6, 2018 (FI) 20185327

(51) Int. Cl. A01G 23/08; F15B 11/02; F15B 11/036; F15B 15/14; F15B 15/16; F15B 15/20

(52) U.S. Cl. CPC A01G 23/08; F15B 11/022; F15B 11/036; F15B 2211/775; F15B 15/16; F15B 15/204; F15B 15/1466

(57) ABSTRACT

A hydraulic actuator includes two or more cylinder parts that nest inside each other, each cylinder part including a piston and piston rod forming an operating element and a cylindrical component, inside which the operating element is arranged, the piston of the inner cylinder part being inside the piston rod of the outer cylinder part, chambers formed for each cylinder part, a pressure-medium feed arrangement creating work-movement in the operating element by the pressure medium led to the chambers, a pressure-difference-controlled valve controlling operation of the hydraulic actuator between a first ducting and a second ducting, controlling the feed of the pressure medium among the chambers and a pressure-difference-controlled spool valve including a housing, connecting chambers and a spool arranged to move backwards and forwards in the housing to open and close the connections creating a work movement alternately by the operating element of the inner or outer cylinder part.

The invention relates to a hydraulic actuator, which includes
two or more cylinder parts arranged to nest inside each other, namely an inner cylinder part and an outer cylinder part, each of which cylinder parts includes a piston and a piston rod arranged to form an operating element and a cylindrical component, inside which the operating element is arranged, and the piston of the inner cylinder part is arranged inside the piston rod of the outer cylinder part,
chambers arranged to be formed for each cylinder part,
a pressure-medium feed arrangement for creating a work-movement in the operating element by the pressure medium led to the chambers, which includes first ducting equipped with a connection arranged to the cylindrical part of the outer cylinder part and second ducting connected to the first ducting, which is arranged to run through the pistons in order to arrange a pressure-medium connection to the chamber of the inner cylinder part,
control means for controlling the operation of the hydraulic actuator.

In addition, the invention also relates to a working device and an energy-wood grapple.

Energy-wood grapples by which standing trees can be felled and moved after felling to a desired location, are manufactured, for example, for excavators. At its simplest, a sharpened counter-blade is added to the wood grapple. When claws or similar close, the tree is pressed against at counter-blade, and are simultaneously cut. After cutting, the tree is held in the claws and can be moved to the desired place. Even several trees can be taken at one time in an energy-wood grapple.

Energy-wood grapples can be used in other work machines than only the aforementioned excavators. Irrespective of the work machine used, the changing and smooth operation of the working devices are important factors when it is wished to get profit with work machines.

Nowadays excavators are increasingly equipped with a bucket rotator. This brings challenges to felling carried out with an energy-wood grapple, because the pressure coming to the rotator is reduced to a level of about 220 bar. This reduces the power of an energy grapple connected to the rotator. An increase in the diameter of the energy-wood grapple's cylinder is a poor solution to this problem, because the rotator's feed-through forms a throttle-point to a larger oil flow. In cutting devices of the prior art, cylinders are used that have a 110-mm piston and demand a pressure of 280-300 bar. The lower pressure of 220 bar due to the rotator is then insufficient to operate the cylinder.

In most of the cutting cycles made by an energy-wood grapple a considerably smaller force than maximum force would be sufficient. When cutting a large tree a larger cylinder is required, the speed of movement of which in turn remains relatively low for the aforementioned reasons and slows the operation of the grapple in light work cycles and also causes energy losses. This significantly affects the machine's productivity. The same problems relating to the cylinder's speed and power exist equally in other fields of industry too, and not only in the energy-wood felling given as an example.

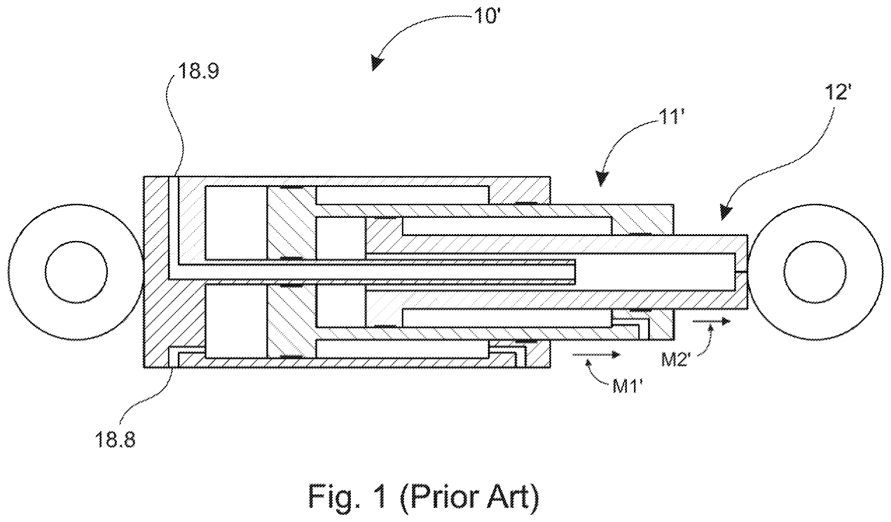

FIG. 1 shows the constructional principle of a variable-power hydraulic cylinder 10′ developed by the applicant, which can resolve the problems presented above. It is described in the internet publication [1] of the Koneviesti magazine (article's publication date Oct. 27, 2016). In it the cylinder 10′ has two parts 11′, 12′, which operate non-simultaneous. In other words, the feed of the pressure medium to the cylinder parts 11′, 12′ is not implemented in common, but takes place through connections 18.8 and 18.9, which are separated from each other. Thus the feed also takes place differently than, for example, in known conventional telescopic cylinders, in which the pressure-medium feed is directed simultaneously to each stage of the hydraulic cylinder.

In the cylinder construction developed by the applicant, the smaller cylinder part 12 is faster and is used to perform most of, for example, the energy-wood felling cutting operations by the work movement M2′. Using the larger cylinder part 11′, in turn, more power is obtained and it is used only when necessary, when the power of the smaller cylinder part 12′ is insufficient. Control means, such as, for example, a sequence valve (not shown), are used to control the operation of the hydraulic cylinder 10′, i.e. whether the movement M2′, M1′ takes place using its small cylinder part 12′ or its larger cylinder part 11′.

The invention is intended to create a hydraulic actuator, which is better integrated in implementation and more reliable in operation, thus to implement the hydraulic actuator in a variable-power form. The characteristic features of the hydraulic actuator according to the invention are stated in claim 1.

By means of the nesting cylinder construction of the hydraulic actuator and the valve integrated in it, first a rapid movement can be performed using the operating element of the inner, i.e. smaller, cylinder part and, for example, only if necessary utilizing the maximum force produced by the operating element of the outer, i.e. larger cylinder part. In addition, using the hydraulic actuator according to the invention it is possible to produce the varying force required using the inner or outer cylinder part. Thus the hydraulic actuator can be said to have variable power.

Owing to the invention, the ducting to the different cylinder parts of the hydraulic actuator is simplified. Common ducting can be used for both cylinder parts. The pressure medium is guided to the cylinder parts using a valve integrated in the hydraulic actuator, which simplifies the implementation of the actuator in terms of ducting.

The valve can be a spool valve and even more particularly a poppet valve and/or a slide valve in operation principle. The operation of the valve is based on pressure differences inside the hydraulic actuator. Thus the operation of the valve and the feed of the pressure medium through the valve to the chambers of the cylinder parts takes place controlled by pressure difference.

According to one embodiment, the tube forming the second ducting and a retainer element fitted to its end can be advantageously utilized to limit the extreme length of the hydraulic actuator as desired. This can be defined by the length of the tube and thus the location of the retainer element inside the piston rod of the inner cylinder part. When the inner cylinder part's piston reaches the retainer element arranged inside the piston rod, the movement of the inner cylinder part stops. At the same time, the tube can also be used to affect the valve itself, thus also preventing the movement of the outer cylinder part.

In an energy-wood grapple shown as an example embodiment, when working with a small tree only the piston of the inner cylinder part, which is smaller than the outer cylinder part's piston, moves in the hydraulic actuator and work is thus rapid. When a larger tree comes, and the power of the hydraulic actuator's inner, i.e. smaller cylinder is not enough, then the larger piston of the outer cylinder part is brought into action. Control of the hydraulic actuator can take place automatically under pressure-criterion control, and more particularly based on the pressure differences experienced by the valve. One can also refer to the work movement created by alternately the inner or outer cylinder parts, depending, for example, on the loading experienced by the work element at the each time.

Owing to the invention, the power of the hydraulic actuator is enough, for example, in the energy-wood grapple to cut even large trees, but nevertheless its operation is fast. Another example of an application of the invention could also be wood-chopping machines. In them the operating principle can be similar to than in an energy-wood grapple. Then instead of cutting a tree the question is only of, for example, splitting a tree. However, the advantages are largely the same.

The use of the hydraulic actuator according to the invention can resolve for example the challenges brought by a low oil output and a reduced pressure. Other additional advantages achieved by the invention appear in the description portion and its specific features from the accompanying Claims.

The invention, which is not restricted to the embodiments and applications described in the following, is described in greater detail with reference to the accompanying figures, in which

FIG. 1 shows an example of a hydraulic actuator according to the prior art,

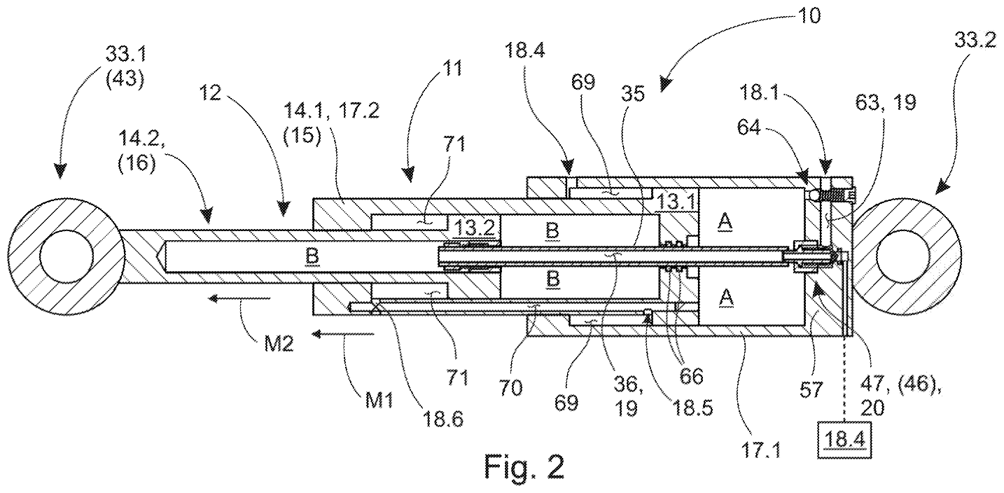

FIG. 2 shows a schematic example of the construction of a hydraulic actuator according to the invention, in a longitudinal cross-section, as a first embodiment,

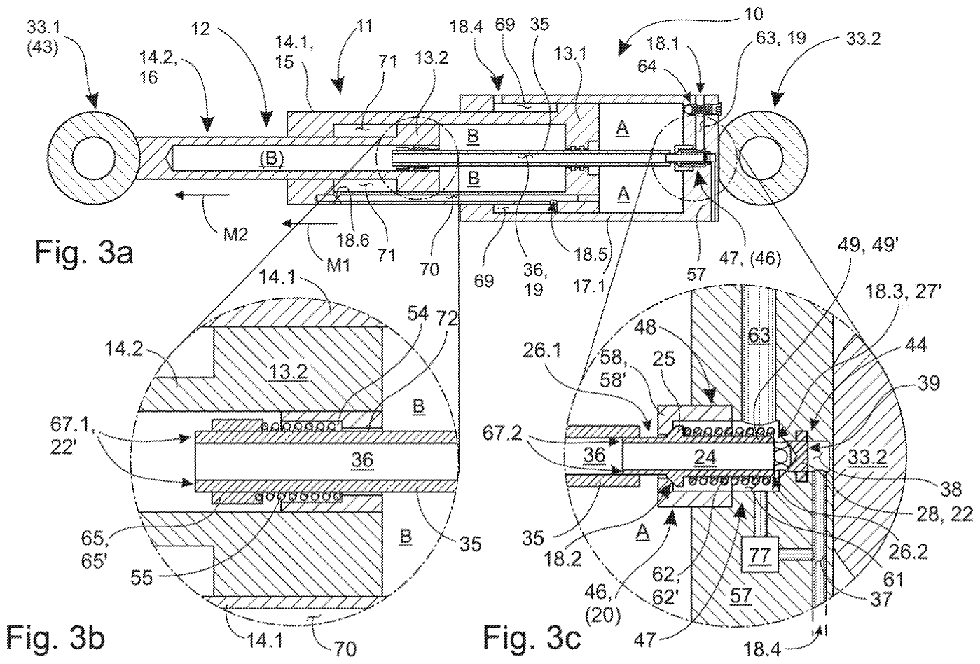

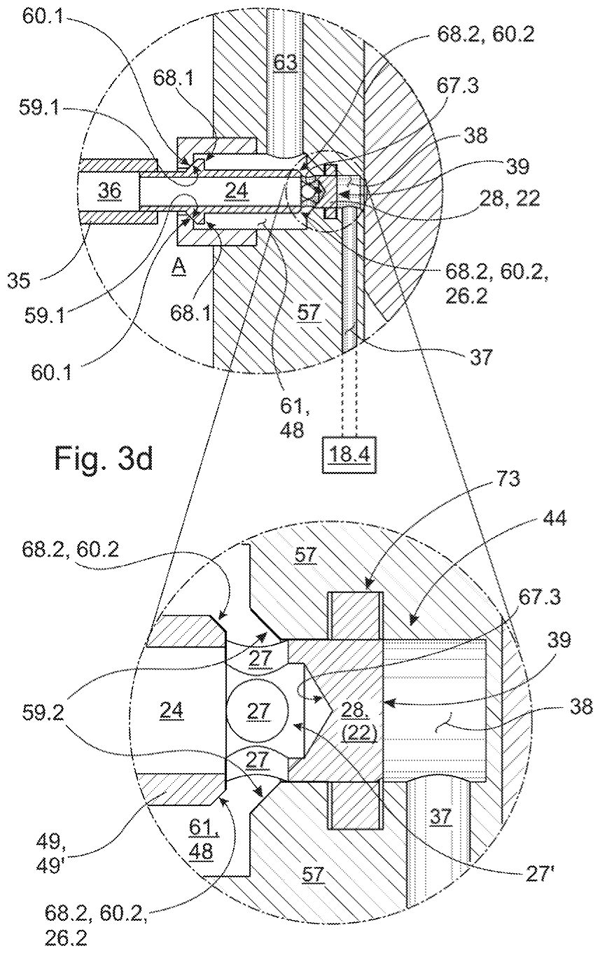

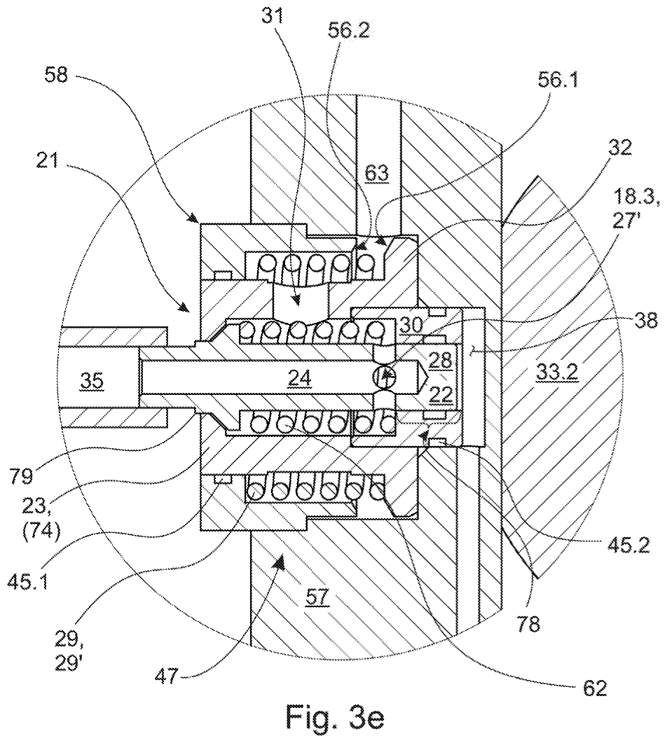

FIGS. 3a-3d show details of the hydraulic actuator shown in FIG. 3 in cross-sectional,

FIG. 3e shows the implementation of the valve of a second embodiment,

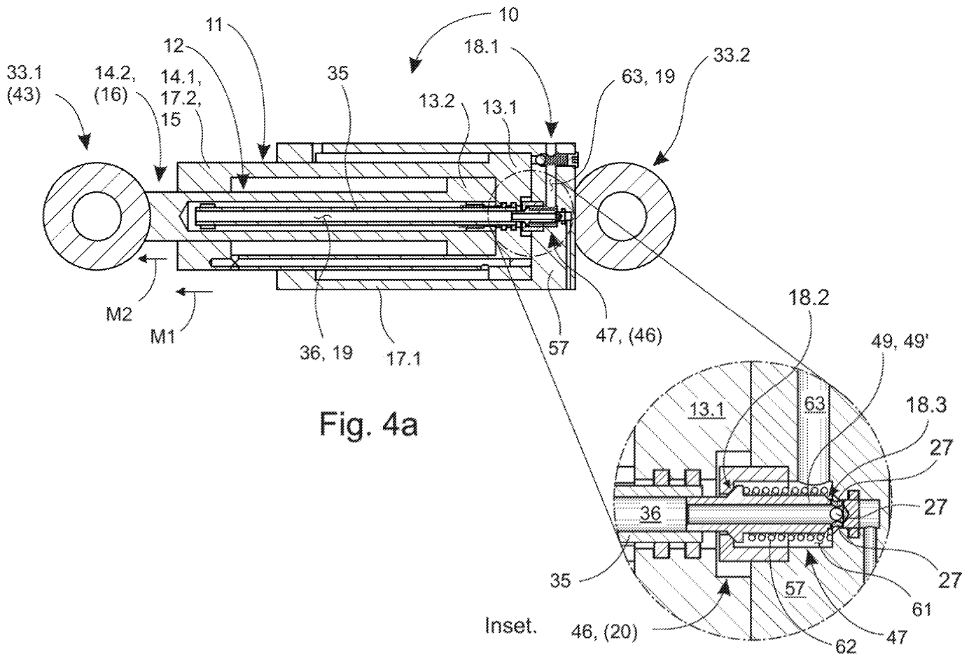

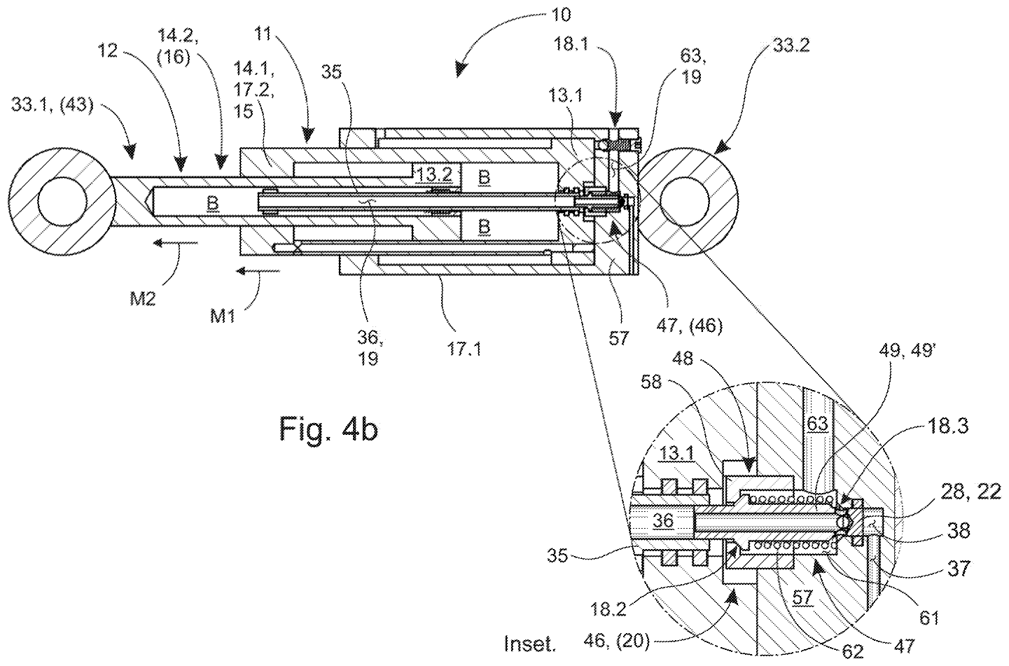

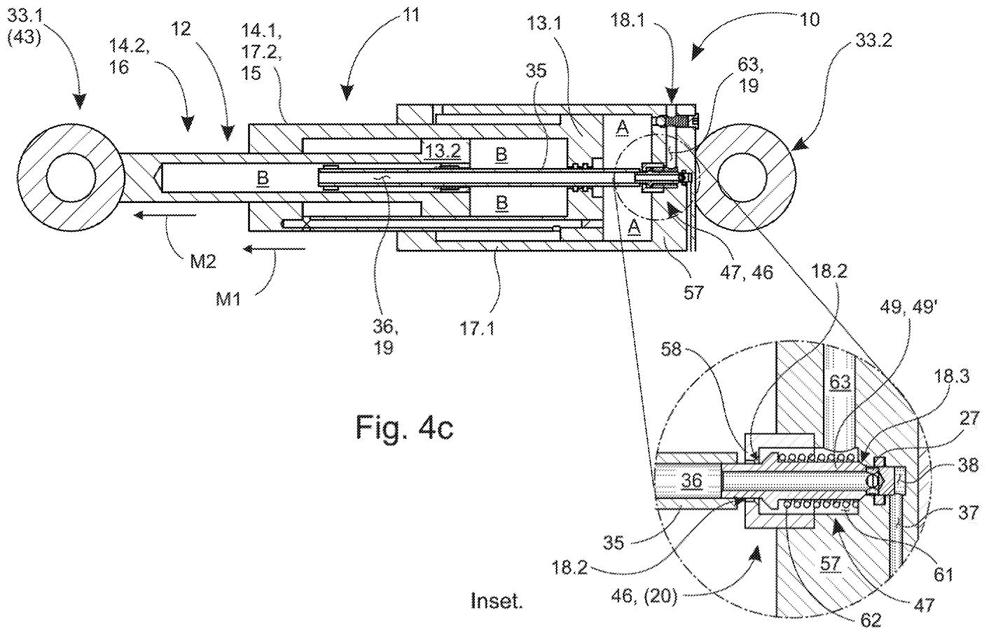

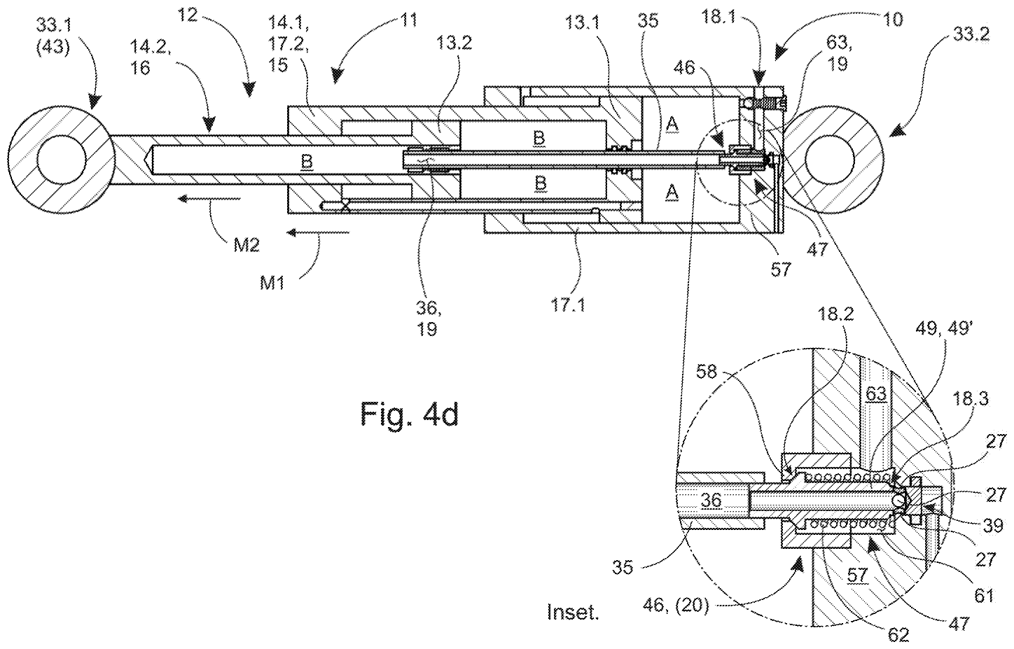

FIGS. 4a-4d show images of the stages of operation of the hydraulic actuator shown in FIG. 3,

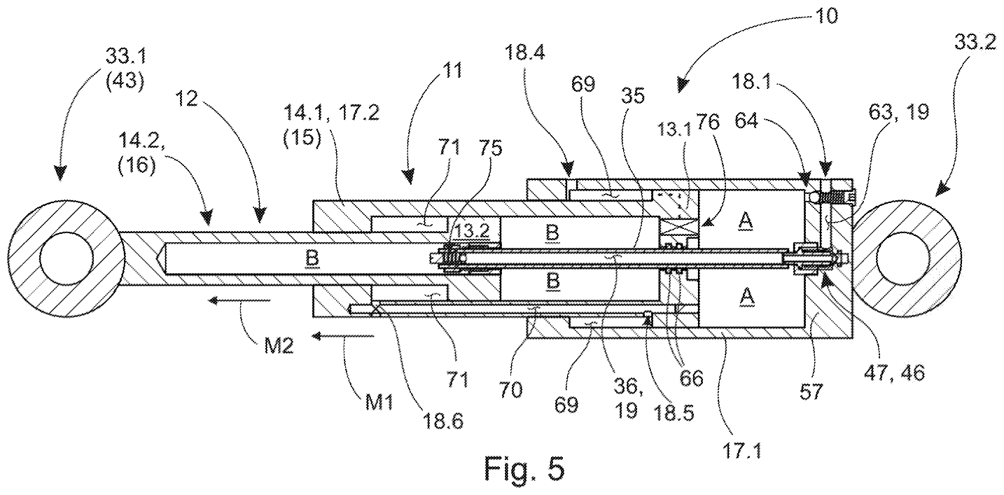

FIG. 5 shows a schematic example of the construction of a hydraulic actuator according to the invention, in a longitudinal cross-section, as a second embodiment,

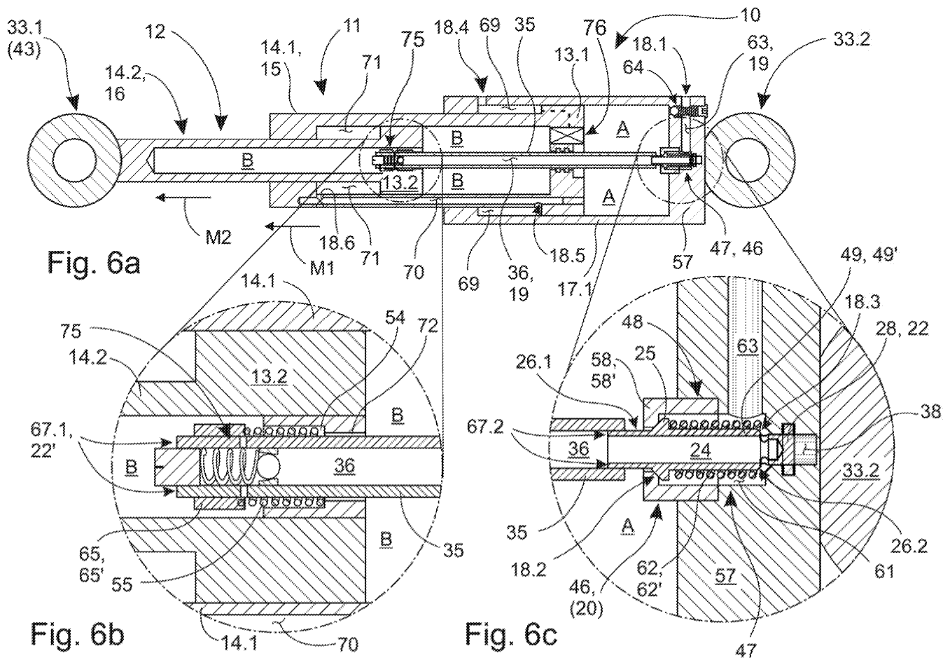

FIGS. 6a-6c show details of the hydraulic actuator shown in FIG. 5 in cross-sectional,

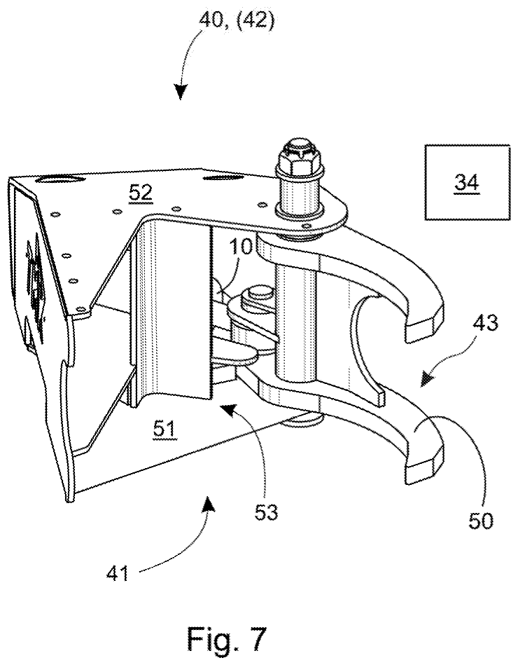

FIG. 7 shows a schematic example of one working device, being an energy-wood grapple, the cutting device of which is equipped with a hydraulic actuator according to any of FIGS. 1-6,

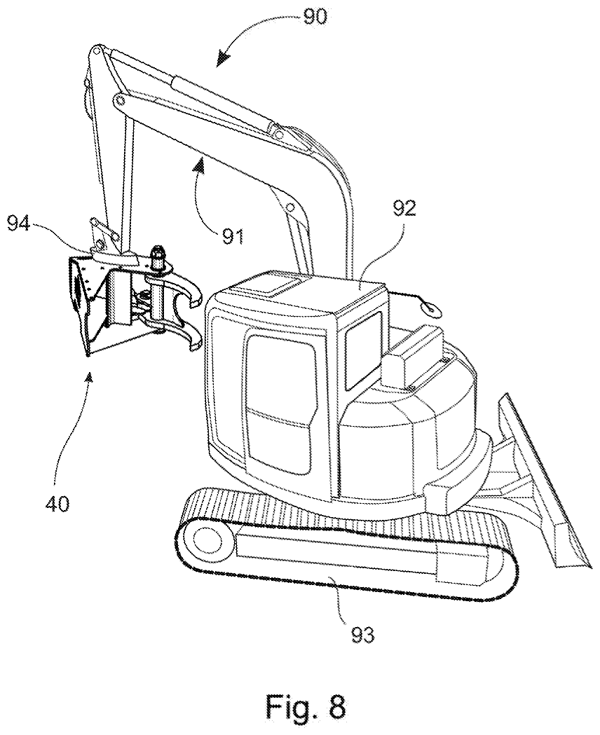

FIG. 8 shows an example of the practical application of the energy-wood grapple in an excavator, and

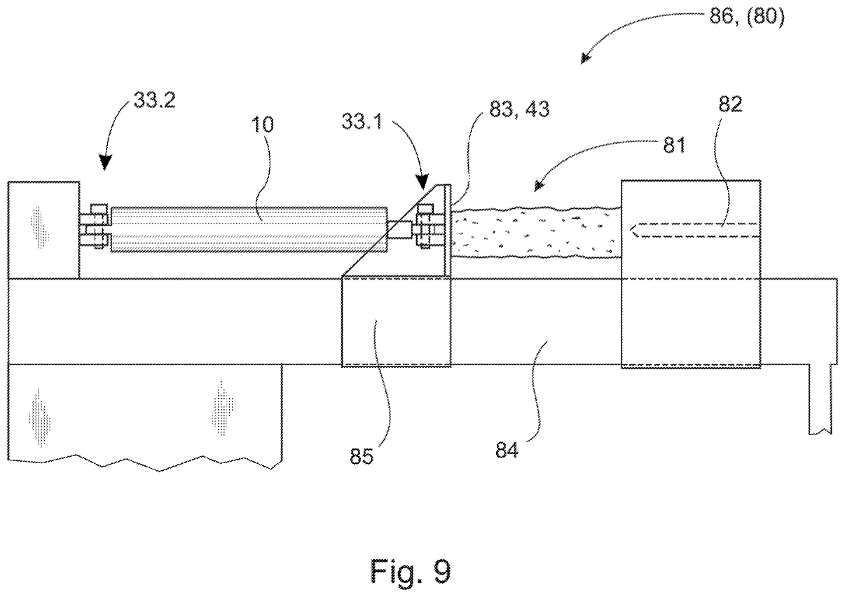

FIG. 9 shows a schematic example of another working device, being a wood-chopping machine or similar splitting device, at least one of the working elements of which is equipped with a hydraulic actuator according to any of FIGS. 1-6.

FIG. 2, and likewise FIG. 5 show schematically some embodiments of the hydraulic actuator 10 in longitudinal cross-section. Instead of a hydraulic actuator, one can also speak in more colloquially of a hydraulic cylinder. The hydraulic actuator 10 includes, as basic parts, two or more cylinder parts 11, 12, chambers A, B arranged to be formed to the hydraulic actuator 10 for each cylinder part 11, 12, and ductings 63, 36 to feed pressure medium to the chambers A, B. The hydraulic actuator 10 includes two or more cylinder parts 11, 12. The cylinder parts 11, 12 are arranged to nest inside each other. In the embodiment shown, there are two cylinder parts 11, 12. The cylinder parts 11, 12 can then be said to be coaxially, i.e. concentrically in the actuator. The cylinder parts can be called, for example, the outer cylinder part 11 and the inner cylinder part 12. The inner cylinder part 12 is then partly inside the outer cylinder part 11, i.e. also closer to the actuator's central axis. In other words, the outer cylinder part 11 is then around the inner cylinder part 12. Thus the inner cylinder part 12 is also the smaller of the cylinder parts and the outer cylinder part 11 the larger. The same also applies to the surface areas of the pistons 13.2, 13.1 of the cylinder parts 11, 12.

Each cylinder part 11, 12 includes, in an as such known manner, a piston 13.1, 13.2 and a piston rod 14.1, 14.2 now connected at one end to the piston 13.1, 13.2. Together the piston 13.1, 13.2 and piston rod 14.1, 14.2 form a working element 15, 16.

In addition, each cylinder part 11, 12 also includes, in an as such known manner, a cylindrical component 17.1, 17.2. The working element 15, 16, or at least its piston 13.1, 13.2 is arranged inside the cylindrical component 17.1, 17.2. The cylindrical component 17.1 of the outer cylinder part 11 now acts as the outer jacket of the hydraulic actuator 10. The hollow piston rod 14.1 of the outer cylinder part 11 now acts as the cylindrical component 17.2 of the inner cylinder part 12. The operating element 16 of the inner cylinder part 12 seals against the hollow piston rod 14.1 of the outer cylinder part 11. The cylinder parts 11, 12 are fitted coaxially relative to each other. Particularly, the inner cylinder part's 12 piston 13.2 is arranged inside the outer cylinder part's 11 piston rod 14.1. The operating elements' 15, 16 piston rods 14.1, 14.2 are arranged to extend partly outside the outer cylinder part's 11 cylindrical component 17.1, more general the actuator 10. Thus both piston rods 14.1, 14.2 extend from an opening arranged in the end of the cylindrical component 17.1, i.e. from the outer jacket of the hydraulic actuator 10, thus extending outside the hydraulic actuator 10 in at least some operating situations of the hydraulic actuator 10. Thus the stroke of the actuator 10 can be made large like a telescopic cylinder, relative to the length of the outer cylinder part's 11 cylindrical component 17.1.

There can be mounting pieces 33.1, 33.2, for example, at both ends of the hydraulic actuator 10 to fit the actuator 10 to its application. Now the mounting pieces 33.1, 33.2 are loops. There is then a loop 33.2 in the end of the cylindrical component 17.1 and an opposite loop 33.1 at the opposite end of the actuator 10 at the end of the piston rod 14.2 of the inner cylinder part 12. The hydraulic actuator 10 is typically fitted to its application in such a way that the outer cylinder part's 11 cylindrical component 17.1, i.e. its jacket is at a suitable point, such as, for example, particularly the loop 33.2, attached to the application and the operating elements 15, 16 move relative to the cylindrical components 17.1, 17.2. Of course this can be the other way round, depending on the application. Or also so that both parts of the application move as a result of the operation of the hydraulic actuator 10, if they are, for example, pivoted to each other. The movement created by the actuator 10 can be, for example, a linear movement or also a rotary movement. In a rotary movement the work element attached to the actuator 10 can be pivoted to the body of the working device or machine, so that it turns, i.e. rotates relative to its pivot point moved by the actuator 10.

For each cylinder part 11, 12 is arranged to form chambers A, B in the actuator 10 at least to create a work movement M1, M2. The chambers A, B are delimited by the actuator's 10 structures, such as, for example, the operating elements 15, 16 and even more particularly the piston 13.1, 13.2, piston rod 14.1, 14.2, and inner surfaces of the cylindrical components 17.1, 17.2. The volume of the chambers A, B can change. Chamber B can also be very small, such as, for example in a situation in which the pistons 13.1, 13.2 touch each other, but it can be said to be formed when pressure medium is led between the pistons 13.1, 13.2, which moves at least one operating element 16.

The hydraulic actuator 10 also includes a pressure-medium feed arrangement 19 to the operating elements 15, 16 to create a work movement M1, M2 by means of the pressure medium led to the chambers A, B. The pressure-medium feed arrangement 19 can generally include, for example, ducts 36, 63, connections 18.1-18.3, valves 46, and control means 34, which control, for example, the flow of pressure medium to create the work movement of the actuator 10 and the possible return movement. The pressure medium is typically a liquid, such as, for example, hydraulic oil. The material of the hydraulic actuator 10 can be mainly, for example, metal.

The feed of the pressure medium to the chambers A, B of the cylindrical components 11, 12 is isolated from each other. In other words, the feed of the pressure medium, for example, to the chamber B of the inner cylinder part 12 does not take place through the chamber A of the outer cylinder part 11. Thus its own pressure-medium feed, which is separate and thus independent from chamber A of the outer cylinder part 11, is arranged to chamber B of the inner cylinder part 12. The same is also implemented for chamber A of the outer cylinder part 11. Thus the pressure-medium feeds can be said to be separate from each other. Thus each cylinder part 11, 12 can be fed with pressure medium separately from the other.

As already stated, due the nesting nature of the cylinder parts 11, 12 they have different pressure surface areas. The piston 13.2 of the inner cylinder part 12 is then the smaller and the piston 13.1 of the outer cylinder part 11 is the larger. Thus with the same volume flow the smaller, i.e. inner cylinder part 12 moves faster than the larger, i.e. the outer cylinder part 11. Pressure-medium feeds isolated from each other arranged to both cylinder parts 11, 12, thus, by the movement of the operating elements 15, 16, an advantage, for example, relating to the working speed of the hydraulic actuator 10 has been achieved.

On the basis of the above, the chambers A, B of the cylinder parts 11, 12 can be unconnected or at least without a direct substantial pressure-medium connection between the chambers A, B. Chamber B of the inner cylinder part 12 and chamber A of the outer cylinder part 11 having no connection the pressure-medium feed to one chamber essentially affects neither the other chamber A nor thus the cylinder part 11 arranged for it, instead operation is created using the cylinder part 12 to which most of the pressure-medium flow as originally intended.

The pressure-medium feed arrangement 19 includes first ducting 63 equipped with a connection 18.1 arranged to the cylindrical component 17.1 of the outer cylinder part 11. The connection 18.1 and the first ducting 63 are intended to lead pressure medium creating a work movement M1, M2 in the actuator 10 to the hydraulic actuator 10 and correspondingly away from it. The first ducting 63 is in the end of the cylindrical component 17.1 radially. Thus the connection 18.1 in its end is in the circumference of cylindrical component 17.1, from which the ducting 63 starts and extends to the actuator's 10 central axis. In other words, the ducting 63 is then at an angle, more particularly now perpendicular to the longitudinal direction of the actuator 10.

Further, the pressure-medium feed arrangement 19 includes second ducting 36 connected to the first ducting 63 fitted to the cylindrical component 17.1. A tube 35, which is arranged to run through the pistons 13.1, 13.2 to arrange a pressure-medium connection to chamber B of the inner cylinder part 12, now acts as the second ducting 36. Using tube 35 it is possible to implement pressure-medium feed to chamber B of the inner cylinder part 12 to move the operating element 16 of the inner cylinder part 12 in the work direction M2 and also the removal of the pressure medium from it.

The second ducting 36 is then arranged at least partly inside the inner cylinder part's 12 piston rod 14.2. For this, there is space inside the piston rod 14.2 for the pressure medium and thus also for the tube 35. In addition, chamber B of the inner cylinder part 12 can then be said to be formed at least partly inside the inner cylinder part's 12 hollow piston rod 14.2. In addition, chamber B is also between the inner cylinder part's 12 piston 13.2 and the outer cylinder part's 11 piston 13.1 and thus inside the hollow piston rod 14.1 in the cylindrical space delimited by the outer cylinder part's 11 piston rod 14.1.

Tube 35 is located on the central axis in the longitudinal direction of the hydraulic actuator 10. Tube 35 runs through chamber A of the outer cylinder part 11 and then through the piston 13.1 of the outer cylinder part 11, through chamber B of the inner cylinder part 12, through the inner cylinder part's 12 piston 13.2, and into the hollow piston rod 14.2 of the inner cylinder part 12. There are openings in the pistons 13.1, 13.2 and also seals 66 in piston 13.1 for the feed-throughs of tube 35. This allows, for example, the pistons 13.1, 13.2 to move relative to tube 35.

On the basis of the above, chamber B of the inner cylinder part 12 can be said to be arranged to form on the side of the piston rod 14.1 of the outer cylinder part 11. Further, chamber B of the inner cylinder part 12 can then be said to be arranged to form on at least part of the work stroke inside the hollow piston rod 14.1 of the outer cylinder part 11. Chamber B can then be delimited directly by the hollow piston rod 14.1 of the outer cylinder part 11 and in addition to be inside the hollow piston rod 14.2 of the inner cylinder part 12, which in turn is also on the side of the outer cylinder part's 11 piston rod 14.1 and also inside it.

Because chamber B of the inner cylinder part is on both sides of its piston 13.2, i.e. on the opposite side of the piston 13.2 to the piston rod 14.2 of the inner cylinder part 12 and in addition also inside the hollow piston rod 14.2 of the inner cylinder part 12, it is thus possible to create a work movement M1 in the inner cylinder part 12 by acting even on both sides of the piston 13.2 with the pressurized medium. In this way a greater pressure surface area is implemented. Without great resistance experienced by the actuator 10 the work movement M1 is created with only the pressure medium brought inside the inner cylinder part's 12 piston rod 14.2. If resistance is met, chamber B between the pistons 13.1, 13.2 comes into play, to which the pressure medium comes through the throttling in the piston 13.2. Further in addition, this construction can be used to ensure the operating of the inner cylinder part.

The work movement M1 of the outer cylinder part 11 is created by means of pressure medium led to the opposite side of the piston 13.1 to its piston rod 14.1, i.e. the first chamber A delimited by the outer cylindrical component 17.1. Here too the same connection 18.1 and the first duct 63 connected to it are utilized, through which the pressure medium can be fed to chamber B of the inner cylinder part 12.

In the hydraulic actuator 10 there is thus a second smaller cylinder inside a large cylinder. In the actuator 10 there are then also two pistons 13.1, 13.2 nesting inside each other. In the larger cylinder's piston, the hydraulic pressure acts over a larger area and the cylinder's power increases relative to the surface area.

The hydraulic actuator 10 further also includes control means 20 for controlling the operation of the hydraulic actuator 10 in the manner already describe above. The control means 20 now includes a valve arranged between the first ducting 63 and the second ducting 36. The valve 46 is arranged to guide the feed of pressure medium between chambers A, B, and even more particularly alternately to chambers A, B. The valve 46 is pressure-difference controlled. This means that the pressure medium is led to chambers A, B by pressure difference controlled with valve 46, and even more particularly, if the situation so demands, alternating the pressure-medium feed between chambers A, B by valve 46.

FIGS. 3a-3d show a first embodiment of the hydraulic actuator 10 shown in FIG. 2 in longitudinal cross-section in greater detail in terms of its implementation of valve 46. Valve 46 can be said to be a pressure-difference-controlled spool valve 47 in its operating principle. It can be said to include a housing 48, to which is arranged to be formed connections 18.2, 18.3 to chambers A, B. In addition, it can be said to also include a spool 49 arranged to move backwards and forwards in the housing 48 to open and close the connections 18.2, 18.3 alternately to chambers A, B.

The valve 46 is formed in such a way that it prevents the pressure medium from escaping from chamber B of the inner cylinder part 12 in connection with the work movement M1 of the operating element 15 of the outer cylinder part 11 to arrange the movement of the operating element 43 of the actuator 10 to be mainly continuous. In the spool valve 47 there is a spool 49 moving backwards and forwards in the housing 48 of the valve 46 and, for example, connections 18.2, 18.3 at opposite ends of the housing 48 to chambers A, B. The spool 49 is arranged to alternately close access, i.e. the connection 18.3, by the pressure medium to the first chamber B and open access, i.e. the connection 18.2 to the second chamber A. The pressure medium then does not also escape from chamber B, because the spool 49 closes access to it, i.e. the connection 18.3 to chamber B arranged in the valve 46. Thus, in addition to the pressure medium being led from connection 18.1 through the first ducting 63 and from there through the following second ducting 36 to chamber B of the inner cylinder part 12, the pressure medium fed to the first ducting 63 can also be led through the valve 46 to chamber A of the outer cylinder part 11. This particularly simplifies the ducting of the actuator 10 for feeding pressure medium to chambers A, B. Thus, owing to the invention the need to arrange separate ductings for both chambers A, B is eliminated.

Valve 46, belonging to the control means 20, for arranging the movement of the operating element 43 to be mainly continuous in connection with the work movement M1 of the operating element 15 of the outer cylinder part 11 is integrated inside the hydraulic actuator 10. It is then well protected from external stresses. The spool valve 47 can be implemented as a slide and/or poppet valve-type solution, as shown in the following embodiments.

FIGS. 3b and 3c show as insets cross-sectional details of the hydraulic actuator 10 shown in FIGS. 2 and 3a. From the inset of FIG. 3c it can be seen that the valve 46, more particularly now a spool valve 47, includes a housing 48 and a spool 49 arranged to move axially backwards and forwards in the housing 48. The spool 49 can also be called a slide on account of its movement. The housing 48 is arranged to be formed in the cylindrical component 17.1 and more particularly its end 57, of the outer cylinder part 11 of the hydraulic actuator 10. The spool 49 is tube-like. The spool 49 is attached rigidly to the second ducting 36 taken through the pistons 13.1, 13.2 to the chamber B of the inner cylinder part 12, and even more particularly to leading inside its cylindrical component 17.2. The tube 35 forming the second ducting 36 is then supported at its one end on the end wall 57 of the cylindrical component 17.1 of the hydraulic actuator 10, through the spool 49. Connection to the tube 35 can take place from one end 26.1 of the spool 49.

In the case of the formation of the connections 18.2, 18.3 reference is especially made to FIG. 3d and even more especially to the inset formed in it in the case of connection 18.3. FIG. 3d and also the inset formed from it do not show the spring 62′, for greater clarity. To arrange openable closable connections 18.2, 18.3 to the chambers A, B, the spool 49 includes in this case counter-surfaces 60.1, 60.2 for the seats 59.1, 59.2 arranged for them in the housing 48. Thus, the housing 48 includes two seats 59.1, 59.2 to form connections 18.2, 18.3 to the chambers A, B. The counter-surfaces 60.1, 60.2 are now arranged in the opposite ends 26.1, 26.2 of the spool 49.

Correspondingly, the seats 59.1, 59.2 are also arranged in opposite sides of the housing 48. Thus, the spool 49 is arranged, in the case of its counter-surfaces 60.1, 60.2, between the seats 59.1, 59.2 of the housing 48. According to the embodiment shown, the valve 46 can be in the case of one or more of its connections 18.2, 18.3 a poppet valve. It then includes at least one seat 59.1, 59.2 and a counter-surface 60.1, 60.2 arranged for at least one seat 59.1, 59.2.

The housing 48 is formed by a drill-hole 61 made in the end 57 of the cylindrical component 17.1. The drill-hole 61 is closed in the direction of chamber A of the outer cylinder part 11 by a sleeve 58′, more generally a cover 58. Thus, the valve 46 includes a cover 58 arranged to close the housing 48 from the side of chamber A of the outer cylinder part 11. The first ducting 63 is arranged to connect to the housing 48, i.e. to lead the pressure medium from the connection 18.1 to the housing 48.

There is an opening in the sleeve 58′ for the spool 49. In addition, in the sleeve 58′, i.e. in the cover 58, there is a first seat 59.1 of the housing 48 for a first counter-surface 60.1 arranged in the spool 49, which together form the first connection 18.2. Thus, the seat 59.1 arranged to form the first connection 18.2 is arranged at the housing's 48 end on the side of chamber A of the outer cylinder part 11, in order to arranged a pressure-medium connection to chamber A of the outer cylinder part 11. The sealing surface formed in the first seat 59.1 is arranged to be sealed the first counter-surface 60.1 opening and closing pressure-medium connection from the housing 48 to chamber A of the outer cylinder part 11. Thus, the first counter-surface 60.1 and the seat 59.1 are used to control the access of the pressure medium and possibly also its exit from chamber A of the outer cylinder part 11. On the bottom of the drill hole 61, i.e. at the opposite end of the housing 48 is, in turn, second annular seat 59.2 for the second annular counter-surface 60.2 arranged in the spool 49. Thus, the second seat 59.2 is formed in the end structure 57 of the cylindrical component 17.1. The sealing surface formed in the second seat 59.2 is arranged to be sealed the second counter-surface 60.2 opening and closing the pressure-medium connection from the housing 48 to chamber B of the inner cylindrical part 12 through the spool 49, and even more particularly, the tube spool 49′. Thus, by the second counter-surface 60.2 and the seat 59.2, access of the pressure medium through the tube spool 49′ to the following tube 35, i.e. to the second ducting 36, is controlled and thus also to chamber B, as is its exit from it. For this purpose, the tube spool 49′ includes an access 27′ formed of one or more openings 27, arranged in the housing 48 in connection with the connection 18.3 to the inner cylinder part 12. The access 27′ is thus in connection with the second end 26.2 of the tube spool 49′. The openings 27 belonging to the access 27′ are perpendicular to tubular elongated tube spool 49′. There are now four openings 27, which are at a 90-degree angle to each other. They can also be said to be two cross-wise pairs of openings.

The first counter-surface 60.1 is in a shoulder 25 arranged in the outer circumference of the spool 49. In the shoulder 25 is a bevelled surface in the direction of chamber A of the outer cylinder part 11, which acts as counter-surface 60.1. The bevelled surface seals the opening of the sleeve 58′ acting as a cover 58 for the housing 48, which acts as a seat 59.1 for the bevelled surface forming the counter-surface 60.2.

The second counter-surface 60.2 is, in turn, fitted to the other end 26.2 of the spool 49. In other words, the second connection 18.3 is arranged at the opposite end of the housing 48 to the end on the side of chamber A of the outer cylinder part 11 to arrange a pressure-medium connection to chamber B of the inner cylinder part 12.

The length of spool 49, the places in spool 49 of the counter-surfaces 60.1, 60.2 arranged in it, the length of housing 48, and the places in the housing 48 of the seats 59.1, 59.2 fitted in it, are arranged in such a way that by a short backwards and forwards axial movement spool 49 alternately closes one connection 18.2 and opens the other connection 18.3, and also vice versa.

It is possible to affect the tube spool 49′ by pressure medium in chamber B of the inner cylinder part 12, through the second ducting 36. According to one embodiment, instead of the fixed installation arranged inside the hydraulic actuator 10 known from the prior art, the tube 35 arranged to run through the pistons 13.1, 13.2, more generally the second ducting 36, can now move axially inside the hydraulic actuator 10, for example, to achieve valve operation by a spool valve 47. In other words, the tube 35 forming the second ducting 36 is arranged to move in the longitudinal direction of the actuator 10, i.e. also parallel to the work movement M1, M2 of the operating elements 15, 16 in the manner of the spool 49 arranged to move in the housing 48. Thus, in addition to pressure-difference-control, the valve 46 can also be said to have mechanical and feedback control. The pressure prevailing inside the hydraulic actuator 10 can act on the valve 46 directly mechanically, for example through the movement transmitted by the tube 35, when one can also speak of dynamic feedback. Thus, through the tube 35 formed the second ducting 36 it is possible to remotely control the operation of the valve 46 by the pressure of the pressure medium of chamber B of the inner cylinder part 12.

Thus, the second ducting 36 can form a functional part belonging to the valve 46, a certain kind of an extension, to the spool valve 47 and thus also to the spool 49 belonging to it. In addition to the spool 49 belonging to the spool valve 46, the second ducting 36 can also be arranged to move with the tube spool 49′ axially backwards and forwards to control the feed of the pressure medium alternately to achieve work movement M2, M1 by the operating element 15, 16 of the inner or outer cylinder part 12, 11.

Thus, the acting moving the spool valve 47 axially backwards and forwards taking place through the second ducting 36 is here mechanical, i.e. the action takes place through movement, because the tube 35 belonging to the second ducting 36 can also move by pressure-difference controlled moving correspondingly also the spool 49 belonging to the spool valve 47. If the spool 49 is rigidly attached to the end of the axially moving tube 35, it too then moves axially backwards and forwards in the housing structure 48.

The tube 35 connects to the spool 49 at a distance to the sleeve 58′, i.e. from the cover 58 of the housing 48. In addition, the opening in the sleeve 58′ for the spool 49 and/or the shaping of the outer circumference of the spool 49 (reference number 79 in FIG. 3e) permits the pressure medium to run through the opening in the sleeve 58′, i.e. the seat 59.1 to chamber A and correspondingly also possibly away from there when the counter-surface 60.1 in the spool 49 is separated from the seat 59.1 formed for it in the sleeve 58′. Thus, in the pressure-difference controlled spool valve 47 it is possible to utilize tube 35 forming the second ducting 36 leading the pressure medium to chamber B, either by directly mechanically moving the spool 49 and/or by at least by leading pressure-medium acting to move the spool 49, more generally functional part that affects the operation of the spool 49.

In the above embodiment, the second ducting 36 can be said to be arranged to act as a piston 22′ for the valve 46 in the opposite movement direction to the work movement M1, M2 of the operating elements 15, 16. The pressure medium of chamber B of the inner cylinder part 12 is arranged to act on the piston 22′. For operation as a piston 22′, the second ducting 36 can include one or more pressure surfaces 67.1. The pressure medium led to chamber B of the inner cylinder part 12, and then to act there, is arranged to be acted on the pressure surface 67.1.

The spool 49 includes one or more effective pressure surfaces 67.2, 67.3, 68.1, 68.2. The pressure surfaces 67.2, 67.3, 68.1, 68.2 arranged to the spool 49 are also arranged to be affected by the pressure medium, to control the operation of the valve 46. More particularly, one or more of the pressure surfaces 67.2, 67.3 arranged to the spool 49 are arranged to be acted on, like the piston 22′, by the pressure medium acting on chamber B of the inner cylinder part 12. The pressure surfaces 67.2, 67.3, 68.1, 68.2 of the spool 49 are arranged to be acted on by the pressure medium to control the operation of the valve 46 preferably in the opposite directions. One or more of the pressure surfaces 68.1, 68.2 arranged in the spool 49 are arranged to be acted using the pressure medium acting in the first ducting 63 and thus also then in the housing 48.

The valve 47 also includes a loading element 62 arranged to affect the spool 49. The loading element 62 is now a spring 62′ or similar arranged in the drill hole 61. The loading element 62 is arranged to act in the opposite direction to the pressure surfaces 67.1-67.3 arranged for the pressure medium acting on chamber B of the inner cylinder part 12. The spring's 62′ springback factor is arranged to be adjusted the operation of the spool valve 47, i.e. the pressure medium feed to chambers A and B based on the pressure differences.

The movement of the spool 49 arises from the effect of the pressure inside the actuator 10. The pressure acts on the effective surfaces of the tube 35 acting as the second ducting 36 and also of the spool 49 itself, which immediately above were called pressure surfaces. In the case of the embodiment marked with reference numbers 67.1-67.3 and 68.1, 68.2 in the insets in FIGS. 3b-3d the formation of the pressure-medium's action, i.e. pressure surfaces is shown.

Annular surfaces, for example, can be reckoned to be part of the pressure surfaces 67.1, 67.2. The seals 66 in piston 13.1 form the outer circumference of the annular surface (diameter for example 18 mm) and the smallest internal diameter of the tube 35 corresponding the inner circumference of the annular surface. The effective annular surfaces acting to the right, i.e. in the opposite direction relative to the work movements M1, M2 are marked with reference numbers 67.1, 67.2. Now they are the annular surface 67.1 at the end of the tube 35 and the annular surface 67.2 of the end 26.1 of the spool 49 inside the tube 35 (diameter for example 8 mm). The counter-force to these when the tube spool is on the left, is formed by the pressure surfaces marked with the reference numbers 68.1, 68.2. These pressure surfaces 68.1, 68.2 are now in the spool 49. They are now the annular surface 68.1 of the step forming the shoulder 25 of the spool 49 (diameter for example 16 mm) and the annular surface 68.2 (diameter for example 8 mm) forming the spool's 49 second counter-surface 60.2, which is arranged to correspond to the second seat 59.2. In the embodiment shown, the annular pressure surfaces 67.1, 67.2 and 68.1, 68.2 of the opposite directions now cancel each other.

In the case according to the embodiment, the tube spool 49′ also includes the closed extension 28 arranged to its end 26.2. More particularly the extension 28 is arranged behind the access 27′ arranged between the housing 48 arranged for the pressure medium in the tube spool 49′ and the duct 24 formed inside the tube spool 49′. The extension 28 includes the pressure surface 67.3 at the end of the duct 24, which is also arranged to be acted on by the pressure medium acting on chamber B of the inner cylinder part 12. Thus, the tube spool 49′ can be said to be closed at one end 26.2. When the pressure in chamber B of the smaller, i.e. inner cylinder part 12 increases to that the pressure surface 67.3 arranged to act on the spool 49 begins to act with a stronger force than the springback force of the spring 62′, the spool 49 then moves to the right. The pressure surface 67.3 corresponds mainly to the cross-sectional surface area of the spool 49, i.e. the cross-sectional surface area of the drill hole 38 arranged for the extension 28. Thus, the extension 28 too can be said to form a piston 22 for the tube spool 49′.

The extension 28 can be said to be arranged to act in the opposite movement direction to the work movement M1, M2 of the operating elements 15, 16 as the piston 22 for the valve 46.

The pressure medium of chamber B of the inner cylinder part 12 is arranged to act on the piston 22. For operation as a piston 22 the extension 28 includes one or more pressure surfaces 67.3. Pressure medium that is led to chamber B of the inner cylinder part 12 and then acts there is arranged to act on the pressure surface 67.3.

In the case according to the embodiment shown, the extension 28 is, in addition to the formation of the pressure surface 67.3 arranged on it, arranged to form, for example, a ventilation arrangement 44 for the spool valve 47. More generally stated, the tube spool 49′ also includes a closed extension 28 arranged to its end 26.2 for acting on the spool valve 47 from outside the hydraulic actuator 10. For this the extension 28 also includes a pressure surface 39 outside the spool valve 47. According to one embodiment, the extension 28 and the pressure surface 39 arranged to it is arranged as part of the aforementioned air-vent arrangement 44. In the ventilation arrangement 44, the external pressure surface 39 of the spool valve 47 is arranged to be acted on by the pressure of the tank line in connection with the work movements M1, M2 of the operating elements 15, 16 of the cylinder parts 11, 12. In other words, the spool 49 of the spool valve 47 can be said to be without a substantial counter pressure. The tank line's pressure can here correspond to atmospheric pressure, but for example in excavators it can typically be a few tens of bars. The chamber 39 can thus be said to be channelled to the air space. This ensures that the valve 46 changes its state when the pressure-medium feed changes from chamber B of the inner cylinder part 12 to chamber A of the outer cylinder part 11. In other words, the ventilation arrangement 44 permits the movement of the spool 49 from left to right.

In addition, the ventilation arrangement 44 can also be arranged for emptying chamber B of the inner cylinder part 12 of pressure medium through connection 18.3 to the housing 48 and from there to the first ducting 63. Then in connection with the return, i.e. minus movement of the actuator 10 pressure surface 39 is in turn arranged to be acted on by the pressure created by the return movement on the operating elements 15, 16 of the cylinder parts 11, 12, i.e. by the pressure led to connection 18.4.

For the extension 28 a second housing 38 is arranged as an extension to housing 48 for the tube spool 49′ of the end 57 of the cylindrical component 17.1 of the outer cylinder part 11, now for the extension 28 equipped with external pressure surface 39 of the spool 49. In the housing 38 there are seals 73 for the extension 28. The ducting 37 is arranged to be connected to the housing 38 for ventilation and/or the pressure creating and thus permitting the return movement. Thus the actuator's 10 connection 18.4 is connected, for example, by an external duct to this ducting 37. In connection with work movements M1, M2 the duct 37 and housing 38 are, however, without pressure and more particularly without pressure medium. Only the pressure of the tank line, such as, for example, the atmospheric pressure or at most a pressure of a few tens of bars then acts on the pressure surface 39. In the embodiment described, the extension 28 is slightly narrower than the tubular part of the spool 49 itself to implement connection 18.3 on the poppet-valve principle. Because the pressure surface 67.3 is immediately behind the access 27′ in the extension 28, its work surface area corresponds to the outer diameter of the extension 28 i.e. the cross-section of the chamber 38.

With the springback force of the spring 62′ arranged to the drill-hole 61 or the force created by some other similar loading element 62 the operation of the spool valve 47, i.e. the pressure-medium feed to chambers A and B is arranged to be adjusted based on the pressure differences. The loading element 62 is used to load the first counter-surface 60.1 (chamber's A, connection 18.2) against its seat 59.1 fitted to sleeve 58′. The pressure medium them does not reach chamber A. The loading element 62 is, however, so dimensioned that it also permits the first counter-surface 60.1 to detach from seat 59.1 when a set pressure criterion defined by the springback force of spring 62 is met and the pressure medium then reaches chamber A. The access of the pressure medium to the tube 35 (and its exit from it) at the opposite end 26.2 of spool 49 then closes. Thus, it can be said that the loading element 62 is dimensioned relative to one or more pressure surfaces 67.3 in such a way that when the set pressure criterion is not met, the loading element 62 is arranged to hold the pressure-medium connection 18.3 open to chamber B of the inner cylinder part 12 and to close in turn the pressure-medium connection 18.2 to chamber A of the outer cylinder part 11.

When the pressure again diminishes in chamber B, i.e. the work element 43 moves, the spring 62′ moves the spool 49 to the left, closing with the spool's 49 first counter-surface 60.1 access by the pressure medium to chamber A and detaching the second counter-surface 60.2 from its seat 59.2, thus opening connection 18.3 and thus allowing the pressure medium in from the end of the tubular spool 49, from there to the tube 35, and from there to chamber B. Thus, the loading element 62 is also dimensioned relative to one or more pressure surfaces 67.3 in such a way that when the set pressure criterion is not met loading element 62 is arranged to hold pressure-medium connection 18.3 open to chamber B of the inner cylinder part 12 and to close pressure-medium connection 18.2 to chamber A of the outer cylinder part 11.

The counter-surfaces 60.1, 60.2 are thus at opposite ends of spool 49 and face away from each other. Seats 59.1, 59.2 in turn are at opposite ends of housing 48 and face towards each other. Thus, the backwards and forwards moving spool 49 can alternately close one pressure-medium connection 18.2, 18.3 to the selected chamber A, B and correspondingly simultaneously open the other pressure-medium connection 18.3, 18.2 to the selected chamber B, A.

In this way the hydraulic actuator 10 and the attached work element 43 are given mainly continuous movement. Then when the outer cylinder part 11 comes into action chamber B of the inner cylinder part 12 is not allowed to empty of the pressure medium already fed to it, but instead it mainly remains there also in connection with work movement M1 of the operating element 15 of the outer cylinder part 11. Thus, the work movement M1 of the outer cylinder part 11 continues from the start also the work movement M2 of the operating element 16 of the inner cylinder part 12, nor is there a break in the operation of the hydraulic actuator 10, as would happen if, for example, chamber B of the inner cylinder part 12 were to be allowed to empty with the movement of the outer cylinder part 11 and in which, in other words, the piston 13.1 of the outer cylinder part 11 would be run first together with the piston 13.2 of the inner cylinder part 12 before the movement of the work element 43 again continues.

The inset of FIG. 3b shows that the second ducting 36 of the side of the inner cylinder part 12, i.e. now tube 35, run through the piston 13.2 in such a way that it also permits the flow of pressure medium through the piston 13.2 into chamber B between the piston 13.2 and piston 13.1 of the outer cylinder part 11, creating work movement M2 in the inner cylinder part 12 and its operating element 16. A small gap 72 remaining between tube 35 and the opening arranged in the piston 13.2 permits this pressure medium to flow back and forward to chamber B between the pistons 13.1, 13.2 and into the hollow piston rod 14.2 of the inner cylinder part 12.

According to one embodiment, the end of the second ducting 36 can include a retainer element 65 arranged to interact with the piston 13.2 of the inner cylinder part 12 to stop the work movement of the hydraulic actuator 10. For this, a housing 54 can also be formed in the piston 13.2 of the inner cylinder part 12 for a spring 55 to be fitted into it. In the end of tube 35 is a retainer sleeve 65′, more generally a retainer element 65, which opposes spring 55. The construction is an example of one way to set a maximum length for the hydraulic actuator 10. When the maximum length is reached, the actuator's work movement stops.

More particularly, the retainer element 65 is, according to one embodiment, arranged to prevent mechanically the work movement M2 of the inner cylinder part 12. This happens when the inner cylinder part's 12 piston 13.2 reaches the retainer element 65. The reaching can take place only as a result of the movement of the inner cylinder part 12, only as a result of the movement of the outer cylinder part 11, or a combination of both.

In addition to mechanical movement prevention, in the embodiment described the retainer element 65 is also arranged to transmit to the spool valve 47 through the second ducting 36 the force caused by the inner cylinder part 12 and even more particularly by its piston 13.2 to also stop the work movement M1 of the outer cylinder part 11, using valve 46. This is one example of the action on the valve 46 obtained using the second ducting 36 formed by tube 35. In other words, here the piston 13.2 is used to act on valve 46 mechanically. In the aforementioned manner, when piston 13.2 reaches the retainer element 65, it pushes it to the left. Because the retainer element is fixed in tube 35, tube 35 too moves left. The valve spool 47 attached to the tube 35 is also pulled to the left, when the first connection 18.2 of valve 46 to chamber A of the outer cylinder part 11 is certain to close. This is because the counter-surface 60.1 arranged to the spool 49 loads tightly against the seat 59.1 in the housing's 48 sleeve 58′.

FIG. 3e shows yet another possible way to implement valve 46. Here shutter means 21 are arranged to the valve's 46 housing 48 to prevent pressure medium from entering the housing 48 from the first ducting 63. This solution also prevents pressure medium from entering the spool 49, i.e. the inner cylinder part 12 in connection with the length limitation. In this way it is thus possible to use valve 46 to create a stopping length limitation in both cylinder parts 11, 12.

The shutter means 21 now include a shutter part 74 moving backwards and forwards in the housing 48. In this case the shutter part 74 is formed of a sleeve-like piece 23, in which is an opening 31 for pressure medium to enter the spool 49 and leave it, relative to the first ducting 63. In addition, there is also a shoulder 32 in the piece 23, by which the shutter action is achieved. First of all, the shoulder 32 closes the ducting 63. In addition, there is also a valve surface 56.1 in the shoulder 32 for the counter-surface 56.2 arranged to the cover 58 closing the housing 48. Using these, entry by pressure medium to the housing 48 is closed. Now the sleeve-like piece 23 forms part of the cover. It seals the opening made for it in the cover 58 through a seal 45.1. The first seat 59.1 of the valve 46 is then also formed in this sleeve-like piece 23. In the embodiment described, the shutter means 21 also include a return element 29, now a spring 29′, arranged in the housing 48 for the sleeve-like piece 23. The springback caused by the spring 29′ is in the opposite direction to the spring 62′ arranged for the spool 49. In the ventilation arrangement 44 end of the housing 48 is a sleeve piece 30 arranged to seal the outer circumference of the second housing 38. It attaches to the sleeve-like piece 23 forming the shutter. In the centre of the sleeve piece 30 is a drill-hole, to which seals the closed extension 28 arranged to the end 26.2 of the tube spool 49′.

The shutter structure described operates in such a way that when the piston 13.2 reaches the retainer element 65 the tube 35 pulls the spool 49 arranged to its end against the spring 29′ of the shutter 21. The spool's 49 shoulder 25 corresponds to the sleeve-like piece 23, which is thus made to move to the left. As a result, the shoulder 32 of the sleeve-like piece 23 closes the duct 63 and the surfaces 56.1, 56.2 come together. This prevents the pressure medium from entering the housing 48 and thus also from there through the valve's 46 second connection 18.3 to the duct 24 formed inside the spool 49. Thus, the entry of pressure medium also to the work side of the inner cylinder part 12, i.e. to chamber B is prevented using this mechanical shutter solution arranged in valve 46.

FIG. 3e shows, in addition, one variation concerning the arrangement of the connections to valve 46. Valve 46 can also be a slide valve in the case of one or more of its connections 18.3. In a slide valve a second housing 38 is arranged as an extension of housing 48 for the tube spool 49′. The area of the second housing 38, which can now also be called a shutter housing, is arranged to be closed the access 27′ arranged for the inner cylinder part 12 in the tube spool 49′. In FIG. 3e the second connection 18.3 of valve 46, through which the pressure medium is led to and from chamber B of the inner cylinder part 12, is here implemented using this slide principle. Valve 46 is then a combined slide and poppet valve. The first connection 18.2 is still implemented using the same seat principle as described above.

In FIG. 3e the second connection 18.3 is shown in the open position. The pressure medium then passes from the housing 48 comprising spring 62′ through access 27′ inside spool 49 to tube 24. When the pressure in chamber B of the inner cylinder part 12 rises, the spool 49 moves to the right. The connection 18.3 then closes, because the openings form the access 27′ in the spool 49 move with the spool 49 to the area 78 sealed by the sleeve-like piece 30. The fit between the drill-hole in the sleeve-like piece 30 and the extension is so tight that pressure medium does not pass from the housing 48 into the spool 49, nor also out of it. In this embodiment there is thus no seat 59.2 and, in addition, the spool 49 and the extension 28 have the same diameter.

The retainer element 65, the movement prevention creating a set maximum length by it, and the effect on valve 46 are optional. The actuator 10 can also be implemented without them. A prevention arrangement that is, for example, external to the actuator 10 can be used to set a maximum movement. In addition, the actuator 10 can also have a pressure limit 77.

FIG. 3e shows an example of the shape of spool 49 at its first end 26.1. The tube spool's 49′ outer circumference now seals on an opening arranged in the sleeve-like piece 23, connection 18.2 being closed. When spool 49 moves to the right, connection 18.2 does not open immediately, instead the sealing continues for some distance. The distance is arranged to correspond to allow the second connection 18.3 time to close. For this there is in the spool's 49 outer circumference, for example, an annular step 79 or similar, which opens to connection 18.2, when spool 49 has moved sufficiently to the right. At the same time connection 18.3 has closed. The step formation 79 thus reduces the outer cross-section of the tube spool 49′ to open connection 18.2. Correspondingly, the construction can be applied in poppet-valve implementations, especially when both connections 18.2, 18.3 are implemented using the seat principle.

The spool valve 47 connects to a first duct 63, at the end of which is connection 18.1 for leading pressure medium to the hydraulic actuator 10 and now correspondingly away from it. From connection 18.1 the pressure medium is led along the first duct 63 to spool valve 47 and out of it.

In the end 57 of the cylindrical component 17.1 or a similar point in the body of the actuator 10 there can also be an optional check valve 64 or similar means for ensuring and accelerating the emptying of chamber A of the outer cylinder part 11. When pressure medium is fed to chambers A, B, the check valve 64 prevents pressure medium from entering through it to chamber A of the outer cylinder part 11. The check valve 64 is so dimensioned that it passes pressure medium from chamber A of the outer cylinder part 11 to the first ducting 63 in connection with the return, i.e. minus movement of the actuator 10, but, however, not when pressure medium is fed from the housing 48 to chamber A.

The hydraulic actuator 10 can be double-acting. In the actuator 10 a single pressure-medium connection 18.4 can take care of the return movement of the cylinder parts 11, 12. Through it pressure medium is led to chamber 69, which is between the cylindrical component 17.1 and the piston rod 14.1 of the outer cylinder part 11. The pressure medium acts of the piston 13.1 of the outer cylinder part 11, on the side of its piston rod 14.1. This creates the minus movement of the outer cylinder part 11. In the piston rod 14.1 of the outer cylinder part 11, there is in turn a connection 18.5, a longitudinal duct 70 in the piston rod 14.1, and a connection 18.6 for leading pressure medium on to the space 71 formed between the outer cylinder part's 11 piston rod 14.1 and the inner cylinder part's 12 piston rod 14.2. The pressure medium then acts on the piston rod's 14.2 side of the inner cylinder part 12 to the piston 13.2. This in turn creates the minus movement of the inner cylinder part 12. This too simplifies the construction of the actuator 10. The return movement is rapid, because the oil chambers 69, 71 of the inwardly directed movement are relatively small. In addition, all the connections 18.1, 18.4 are on the cylindrical component 17.1 of the hydraulic actuator 10, to which usually only very little movement, if any at all, is directed. Thus, very little motion stress acts on the hoses connected to them and, in addition, these are protected, for example, inside the body 52 of the application device.

FIGS. 4a-4d show in stages the operation of the hydraulic actuator 10 described above. At the same time, reference is made to the insets shown in FIGS. 3b-3d. FIG. 4a shows an example of the operation of the actuator 10 from the initial situation. In it the actuator 10 is at its minimum length and the pressure feed in the +-direction is started. As the spring 62 of the spool valve 47 loads the spool 49 and more particularly the first counter-surface 60.1 in it against its seat 59.1, the pressure medium cannot pass between the counter-surface 60.1 and the seat 59.1 and through the following sleeve 58′ to chamber A of the outer, i.e. larger cylinder part 11. As the spool structure 49 presses as the spring 62 loaded against sleeve 58′ the second counter-surface 60.2 at the opposite end of the spool 49 is in turn off the seat 59.2. As a result, the pressure medium flows from duct 63 through housing 48, connection 18.3, and access 27′ into the tube spool 49′ and from there to the tube 35 going inside the piston rod 14.2 to the inner cylinder part 12, i.e. to the second ducting 35 and through it also to chamber B between the pistons 13.1, 13.2. The pressure of the pressure medium then begins to act in chamber B of the smaller, i.e. inner cylinder part 12 and the cylinder part's 12 operating element 16 begins to move to the left according to movement M2.

FIG. 4b shows an example of a situation, in which pressure medium has been led as described above to chamber B of the inner cylinder part 12 and a work movement has been created by the operating element 16 of the inner cylinder part 12. At some point in this work movement it may happen that the actuator 10 meets opposition. In other words, the force of the inner cylinder part 12 is no longer enough to create movement. The movement of the actuator 10 then stops momentarily and the pressure in chamber B of the smaller, i.e. inner cylinder part 12 increases over the limit pressure, which may be, for example, 150 bar. The pressure acts on the tube 35 and then also on the spool 49 thus moving them axially, for example, from the aforementioned one or more surfaces 67.3. As a result of this, tube 35 and at the same time also the spool 49 attached to its end move to the right, because the forces due to the increased pressure in chamber B overcome the springback force of the housing's 48 spring 62′.

FIG. 4c has shown precisely the situation like that referred to above, in which the resistance meeting the work element 43 has been sufficiently large and as a result of which the outer, i.e. the larger cylinder part 11 has started to move. This is a result of the spool 49 moving to the right in its housing 48. As a result, access by the pressure medium to chamber A of the larger, i.e. outer cylinder part 11 through connection 18.2 has opened, when the counter-surface 60.1 has detached from seat 59.1. The inner, i.e. the smaller cylinder part 12 is, in turn, locked hydraulically, i.e. the pressure medium cannot escape from its chamber B. This is in turn a result of the counter-surface 60.2 having pressed against the seat 59.2, thus closing the pressure medium's access to and at the same time also its exit from chamber B through tube 35 and tube spool 49′. In this situation, the outer cylinder part 11 is thus arranged to act on the inner cylinder part 12 indirectly, through the pressure medium in chamber B of the inner cylinder part 12. In other words, the inner cylinder part 12 is moved here by the outer cylinder part 11, through the agency of the pressure medium of chamber B. The pressure in chamber B of the smaller, i.e. inner cylinder part 12 then initially increases, because when the second connection 18.3 closes the pressure medium can no longer exit from it, i.e. from chamber B.

With reference to FIG. 4c, a situation is now also described, in which a variable force can appear. The length of the actuator 10 then increases by the force created by either the smaller, i.e. the inner cylinder part 12 or the larger, i.e. the outer cylinder part 11. When the resistance in the actuator 10 again diminishes, the internal feedback of the actuator 10 once again moves the spool 49 to the left and the smaller, i.e. inner cylinder part 12 continues its movement. Thus, when the resistance diminishes the loading acting on the operating element 16 of the inner cylinder part 12 also diminishes and the pressure in its chamber B diminishes. Correspondingly, if the resistance again increases, then the larger, i.e. outer cylinder part 11 assists when necessary. The pressure in the smaller, i.e. inner cylinder part 12 varies according to the load, depending on whether the larger, i.e. outer cylinder part 11 participates in the work and what kind of resistance the inner cylinder part's 12 operating element 16 experiences externally. It can then also be said that the work movement M2, M1 is created by the actuator 10 using alternately the inner or outer cylinder part 12, 11. At each time the choice of the cylinder part 11, 12 used during work movement is determined by the resistance experienced by the work element 43, which can vary during the different work stages and thus cause a pressure difference between chambers A and B, on the basis of which valve 46 guides the pressure medium to the set chamber A, B.

FIG. 4d shows the length-limitation property arranged in the actuator 10. The maximum force at the extreme length of the actuator 10 can be limited to the force produced by the smaller, i.e. inner cylinder part 12. As stated already above, when the mechanical spring-loaded stopper (spring 55) in the piston 13.2 of the smaller, i.e. inner cylinder part 12 strikes the retainer sleeve 65′ arranged in tube 35, the tube spool 49′ moves to the left. The movement of the larger, i.e. outer cylinder part 11 is then prevented and the smaller, i.e. inner cylinder part 12 is only affected by the maximum operating pressure. Thus the force arising in this length is at its maximum the surface area of the small cylinder * the maximum operating pressure. In addition, the actuator's 10 length can be prevented externally from ever growing greater than this length. In this way it is possible even to eliminate the retainer element 65, as it is no longer at the end of tube 35, and even the spring 55 is lacking. Of course, here the implementation of FIG. 3e can be utilized in addition.

The control means 20 are arranged to control the pressure-medium feed arrangement 19 to crate the work movement M2, M1 in stages, first by the inner cylinder part 12, more particularly by its operating element 16, and then, when a set pressure criterion is met, by the outer cylinder part 11, more particularly by its operating element 15. When it is exceeded the pressure-medium feed takes place to the outer cylinder part 11 and then, for example, more power is obtained owing to the larger size of the outer cylinder part 11, if this is needed.

The behaviour of the spool valve 47 can also be controlled using suitable throttling. I.e., for example, by making a suitable throttling at some point in the tube hole, i.e. the second ducting 36, the oil flow coming from inside the inner cylinder part 12 is made to push the spool 49 to the right and thus close the exit of the oil from chamber B of the inner cylinder part 12. Then, however, to permit the minus movement spool 49 is equipped with a separate block for this. For this purpose the previously described extension 28 in the end of the spool 49 can be utilized, with its arrangement creating air-venting and a return movement. The throttle can be at any point at all in the tube duct 35 of the smaller, i.e. inner cylinder part 12. Thus, the pressure difference, on which the movements and operation of spool 49 are based, can also be caused using throttling.

FIGS. 5 and 6a-6c show a schematic example of the construction of the hydraulic actuator 10 according to the invention, in a longitudinal cross-section, in a case according to a second embodiment. The same reference numbering as already used in the embodiment described above is used for components corresponding functionally to each other. In other ways, this corresponds largely to the embodiment described already above, but the implementation relating to the spool valve 47 and the second ducting 36 is here slightly different.

Here, there is a check valve 75 at the end of the tube 35 forming the second ducting 36. It allows pressure medium from the tube 35 to chamber B, but not, however, back from there. The pressure medium exits chamber B through a counterbalance valve 76 fitted to the piston 13.1 of the outer cylinder part 11. The control of the counterbalance valve 76 is taken from the pressure creating the return movement. In this embodiment, there is no need at all for the air-venting arrangement 44 behind the spool 49 and the related ducting 37.

With reference to FIGS. 2 and 3-3d, there is also an embodiment, in which the access 27′ to the inner cylinder part 12 belonging to the tube spool 49′ is arranged to form a throttle for the flow of pressure medium between the housing 48 and the tube spool 49′. At the end 26.2 of the spool 49 there is then one or more openings in its tubular part 24. The openings act as throttles. In this embodiment the air-venting arrangement 44 can also be replaced by a counterbalance valve arranged in the piston 13.1 of the outer cylinder part 11.

Generally, the movement of the spool 49 can thus be said to be pressure-controlled and even more particularly pressure-difference controlled. The feedback is internal, i.e. it takes place on the basis of the forces and pressure differences inside the hydraulic actuator 10, which directly affect the valve spool 49, for example through pressure surface 67.3. The forces act directly on valve 46 moving it axially from one position to another and in addition loading it to hold it in a specific axial position. As a result of the pressure-controlled movement, the flow connection 18.2, 18.3 to chambers A, B closes or opens alternately depending on the pressures in chambers A, B and more particularly on their differences. Ultimately, the pressures are affected by the resistance acting on the work element 43, which can change during the work cycle and thus dynamically control the operation of the actuator 10 and its cylinder parts 11, 12. Thanks to the tube spool 49′, valve 46 forms a surprising coaxial duct at the first connection 18.2 in the actuator's 10 longitudinal direction, thus differing, for example, from the conventional solid-spool poppet and slide valves. The first connection 18.2 is then thus on the outer circumference of spool 49 and at a corresponding point inside the tube spool 49′ a duct 24 is fitted, thus permitting pressure medium to be led into the inner cylinder part 12.

FIG. 7 shows one embodiment of the working device 42, which the invention also concerns and which utilizes the hydraulic actuator 10 according to the invention. The working device 42 can include one or more hydraulic actuators 10 arranged to use the moving work element 43 belonging to the working device 42.

FIG. 7 shows an exemplary energy-wood grapple 40, in which the hydraulic actuator 10 can be utilized and which now acts as an example of one working device 42. Thus, according to one embodiment the working device 42 can be precisely an energy-wood grapple 40. The energy-wood grapple 40 includes a body 52, a cutting device 41 arranged to the body 52 for cutting a tree, and a hydraulic actuator 10 arranged to operate the cutting device 41, to which a work element 43, such as, for example claws 50 belongs. The hydraulic actuator is now, for example, one of the hydraulic actuators 10 described above. In addition, the energy-wood grapple 40 includes control means 34 for controlling the operation of the hydraulic actuator 10. The control means 34 can be, for example, a directional control valve.

The cutting device 41 can be, for example, an operational totality formed of the claw 50 and a cutting blade 51 shown in the figure. The hydraulic actuator 10 is then arranged to act on, for example, the claw 50, which acts as the work element 43. Thus, the hydraulic actuator 10 is arranged to move the work element 43, such as, for example, claws 50. The cutting device 41 can also be based, for example, on a guillotine cutting. Its blade then moves and the hydraulic actuator 10 acts on its blade. In the energy-wood grapple 40 there can also be de-limbing means, such as a de-limbing blade (not shown).

In the embodiment of FIG. 7, the question is of a single-grip grapple, in which a single claw 50 is used to press the tree against the blade 51. The claw 50 together with the body 52 delimits a throat 53. The tree presses against the blade 51 being at an angle, while being simultaneously cut. At the narrow end of the body 52 the energy-wood grapple 40 is attached, for example, to the boom of an excavator. Between these can be the rotator of the energy-wood grapple 40.

The single-grip grapple's claw 50 can be operated by a single hydraulic actuator 10, which is located inside the case-like body 52. The hydraulic actuator 10 is then attached by the loop 33.2 fitted to the end of the cylindrical component 17.1 for example, to the energy-wood grapple's 40 body 52. At its opposite end the hydraulic actuator 10 is secured to a lug fitted to the claw 50 from the loop 33.1 at the end of the piston rod 14.2 of the inner cylinder part 12. Thus, the actuator 10 is well protected. At the same time, a short but large cylinder can be used. Using the hydraulic actuator 10 disclosed in the application, the movement of the claw 50 is made rapid and at the same time powerful enough to cut even a thick tree.

The following description is of the operation of the energy-wood grapple 40 and also of the hydraulic actuator 10 fitted to it and shown, for example, in FIGS. 2-6. When the claws 50 are open, the operating elements 15, 16 of the actuator 10 are mainly inside the cylindrical components 17.1, 17.2 so that the length of the actuator 10 is in its shortest position (FIG. 4a). Their pistons 13.1, 13.2 can then be against each other and at the end at the loop 33.2 side of the cylindrical component 17.1. Once the energy-wood grapple 40 has been taken next to the tree, the claw 50 is closed. Pressure medium is then led to the actuator 10 from connection 18.1 and through the duct 63 attached to it to valve 46 and from there to chamber B of the inner cylinder part 12. As a result, the operating element 16 of the inner cylinder part 12 begins to push outwards, i.e. to create its movement M2. Pressure-difference-controlled valve 46 then prevents the pressure-medium flow from entering connection 18.2, which is now closed by spool 49, and thus also chamber A of the outer cylinder part 11. Thus, the inner small piston 13.2 starts moving first, because spool valve 47 between the first ducting 63 and the second ducting 36 guides the flow first to chamber B. This stage is shown in FIG. 4b.

If the tree is cut with only work movement M2 of the inner cylinder part 12, there is no need at all for work movement M1 of the outer cylinder part 11. Cutting achieved with only the inner cylinder part 12 is, per event, relatively rapid compared to cutting the tree using a traditional single-stage cylinder.

If, however, the tree is not cut through with only work movement M2 with only the inner small-diameter cylinder part, the movement then either slows or even stops entirely. As a result, the pressure rises in the line 36 leading pressure medium to chamber

B of the first cylinder part 12, more generally in the pressure circuit. The pressure-difference-controlled spool valve 47 then opens to chamber A and pressure medium can then flow from duct 63 through connection 18.2 of valve 46 to chamber A of the outer cylinder part 11. This creates movement M1 for the operating element 15 of outer cylinder part 11.

The pressure medium earlier led to chamber B of the inner cylinder part 12 remains there due to the implementation of valve 46. Piston 13.1 of operating element 15 of the outer cylinder part 11 then pushes piston 13.2 of the inner cylinder part 12 through the pressure medium of chamber B and thus in turn also moves the operating element 16 on the inner cylinder part, the end of which is pivoted to the claw 50. FIG. 4c shows this stage. Thus, a greater force, with which the tree is certain to be cut, is created with the aid of the outer larger-diameter cylinder part 11, if the smaller inner cylinder part 12 has not been able to do so. In other words, at the stage at which the load resisting the movement of the smaller piston 13.2 becomes too great, the pressure in the hydraulic line rises as a result of the load and spool valve 47 opens the flow route of the hydraulic pressure medium to the larger piston 13.1, i.e. to chamber A.

The entire available stroke and/or power of the hydraulic actuator 10 is not necessarily required in cutting. This can be take into account in the installation of the hydraulic actuator 10 in energy-wood grapple 40. In addition, the strokes of the operating elements 15, 16 of the cylinder parts 11, 12, for example, can be restricted. If, for example, the maximum force is not required over the whole area of movement, then the movement of the piston 13.1 of the outer, i.e. larger cylinder part can be restricted to be shorter. Thus, the actuator 10 can be constructed in such a way that its maximum length does not consist of the sum of the cylinder parts 11, 12, as it does with telescopic cylinders, instead the actuator 10 stops when either cylinder part 11, 12 reaches its full stroke.

Correspondingly, the opening of the claw 50 is achieved with the return, i.e. minus movement of the hydraulic actuator. Pressure medium is then led out of chambers B and A and correspondingly pressure medium is led from connections 18.4 and 18.6 along ducts to chambers 69, 71 connected to them. Both operating elements 15, 16 can then be acted on, which ensures the opening of the claw, even though the cut tree has, for example, wedged in the cutting device 41.

Yet another application of the invention can be a work machine, an example of which is shown in FIG. 8. The work machine is now an excavator 90. The excavator 90 or other corresponding forestry machine includes a set of booms 91, a rotator 94, which can also be called a rototilt, fitted to the end of the set of booms 91, and an energy-wood grapple 40 according to the invention fitted to the rotator 94. The set of booms 91 is attached to a chassis machine 92, which can move, for example, on crawler tracks 93.

In pilot-stage tests made by the applicant with the energy-wood-grapple, it has been observed that, in energy-wood felling, the inner, i.e. smaller and thus also faster cylinder part 12 can be used to cut 80% of the trees on a certain type of work site (for example, ditch edges in fields). In the grapple according to the example, the smaller cylinder part 12 is by itself able to cut a tree of about 10 cm. The invention then substantially accelerates felling and thus increases its productivity.

Owing to the arrangement and hydraulic actuator 10 according to the invention, greater speed of movement is gained with the inner, i.e. smaller cylinder part 12 and even more particularly its operating element 16, if the loading is less and only when necessary is the larger surface area used, i.e. the outer and thus larger cylinder part 11, and more particularly its operating element 15, with which greater power is obtained. Thus, the actuator 10 can be said to be variable-power.

One skilled in the art will understand that when pressure medium is led to one chamber, then pressure medium is removed from its counter-chamber. In addition, the pressure surface areas of the pistons 13.1, 13.2 can be arranged in such a way that an optimal relation between power and speed of movement is achieved for each application. For example, the diameters of the pistons 13.1, 13.2 can be 130 mm and 80 mm. More generally, the diameter of the piston 13.2 of the inner cylinder part 12 can be, for example, 40-70%, and even more particularly, 50-70% of the diameter of the piston 13.1 of the outer cylinder part 11.

By using the actuator 10 according to the invention several significant advantages are gained. Using it, integrated internal control of the hydraulic actuator 10 can be implemented. The construction is compact, compared, for example, to external valves to arrange the movement of the work element 43 of the cylinder 10 to be continuous, of which examples can be given of some external pressure-controlled valve, such as, for example, a lock valve or counterbalance valve, or an electrically controlled valve or sequence valve or a logic-controlled electrical valve. Thus, capital is not tied up in external valve equipment.

The construction can be used to achieve the integration of the locking property of the inner, i.e. smaller cylinder 12. The small cylinder 12 does not then flex when the larger cylinder comes into play, i.e. there is no delay when the large cylinder 11 comes into play. In addition, the use of the construction creates a limit to the maximum force in the extreme length of the actuator 10 and mechanical forced control of the check valve. This protects the structures. Owing to hydraulic actuator 10 according to the invention, for example in energy-wood-grapple operation unnecessary stressing of the grapple's body is avoided.

FIG. 10 shows as yet another example of the working device a wood-chopping machine 80, or even more particularly a splitting device, which can form part of a wood-chopping machine. In it the actuator 10 can be applied in a manner analogous to the energy-wood grapple 40. The actuator 10 then acts on the wood 81 to be split, for example, by pushing it against a splitting blade 82 belonging to the wood-chopping machine 80. Between the wood 81 and the actuator 10 there can be a pushing check 83, which thus now acts as the operating element 43. The hydraulic actuator 10 and the splitting blade 82 are supported on the splitting machine's 80 frame 84. This can take place, for example, at the opposite end 33.2 of the actuator 10 to the operating element 43. The pushing check 83 can be in a cradle 85 fitted moveably to the frame 84. Before splitting the wood 81 there can also be a cutting device (not shown) in the wood-chopping machine 80. It can be, for example, a chain saw or even a similar guillotine cutting to that in the energy-wood grapple described above. A hydraulic actuator 10 according to the invention can then also be used in possible cutting too. More generally, the working device 42 is a wood-chopping machine 40, which includes a frame 84 and a splitting device 86 for splitting wood 81 fitted to the frame 84. The splitting device 86 includes a blade 82 and a hydraulic actuator 10 arranged to operate the blade 82 to split the wood 81. Thus, the blade 82 too can be moved against the wood 81 by the actuator.

The power and speed advantages when splitting wood 81 with the actuator 10 correspond well to those in the exemplary energy-wood grapple. The actuator 10 according to the invention can be utilized in any application, i.e. working device whatever, without being restricted to the energy-wood grapple or wood-chopping machine referred to as only point of examples in the present application.

The hydraulic actuator 10 according to the invention is particularly advantageous, such as, for example, in applications with a lower pressure and volume flow, for example, when operating an energy-wood grapple, for example, with a rotator, i.e. rotation device.
[1]: https://www.koneviesti.fi/artikkelit/muuttuvavoimainen-sylinteri-1.165938

1-31. (canceled)

32. A hydraulic actuator comprising:
two or more cylinder parts arranged to nest inside each other, namely an inner cylinder part and an outer cylinder part, each of which cylinder parts comprises a piston and a piston rod arranged to form an operating element and a cylindrical component, inside which the operating element is arranged, and the piston of the inner cylinder part is arranged inside the piston rod of the outer cylinder part;
chambers arranged to be formed for each cylinder part;
a pressure-medium feed arrangement to create a work-movement in the operating element by a pressure medium led to the chambers, comprising first ducting including a connection arranged to the cylindrical component of the outer cylinder part and second ducting connected to the first ducting, which is arranged to run through the pistons to arrange a pressure-medium connection to chamber of the inner cylinder part; and
a pressure-difference-controlled valve to control the operation of a hydraulic actuator arranged between the first ducting and the second ducting, and arranged to control the feed of the pressure medium among the chambers and an operating principle of the valve is a pressure-difference-controlled spool valve comprising a housing, in which there are connections to chambers and a spool arranged to move backwards and forwards in the housing to open and close the connections to create a work movement alternately by means of the operating element of the inner or outer cylinder part.

33. The hydraulic actuator according to claim 32, wherein
the first connection is arranged to the end of the housing on the side of chamber of the outer cylinder part to arrange a pressure-medium connection to chamber of the outer cylinder part; and
the second connection is arranged to the opposite end of the housing to chamber of the outer cylinder part to arrange a pressure-medium connection to chamber of the inner cylinder part.

34. The hydraulic actuator according to claim 32, wherein
the housing is arranged to be formed in the cylindrical component of the outer cylinder part and the first ducting is arranged to connect to the housing; and
the spool is a tube spool and is connected to the second ducting.

35. The hydraulic actuator according to claim 34, wherein
the tube spool is arranged to move in the housing in the longitudinal direction of the actuator; and
the tube spool is arranged to be acted on by the pressure medium of chamber of the inner cylinder part, through the second ducting.

36. The hydraulic actuator according to claim 34, comprising one or more pressure surfaces in connection with the tube spool, which are arranged to be acted on by the pressure medium acting on chamber of the inner cylinder part, through the second ducting.

37. The hydraulic actuator according to claim 34, wherein the tube spool comprises an access formed of one or more openings arranged in connection with the connection arranged to the housing to the inner cylinder part.

38. The hydraulic actuator according to claim 34, wherein an extension comprising a pressure surface is arranged to an end of the tube spool, which is arranged to be acted on by the pressure medium acting on chamber of the inner cylinder part.

39. The hydraulic actuator according to claim 34, comprising a closed extension for the air-venting arrangement of the spool valve in an end of the tube spool.

40. The hydraulic actuator according to claim 38, wherein the extension comprises a pressure surface external to the spool valve, to ventilate the spool valve, which is arranged to be acted on by the pressure of a tank line, in connection with the work movement of the operating element.

41. The hydraulic actuator according to claim 40, wherein a second housing for the extension is arranged as an extension of the housing arranged for the tube spool, to which ducting, arranged for the ventilation, is arranged to be connected.

42. The hydraulic actuator according to claim 38, wherein the extension comprises a pressure surface external to the spool valve, which is arranged to be acted on, in connection with the return movement of the hydraulic actuator, by the pressure created by the return movement on the operating elements of the cylinder parts.

43. The hydraulic actuator according to claim 42, wherein a second housing for the extension is arranged as an extension of the housing arranged for the tube spool, to which ducting, arranged for the pressure medium creating return movement, is arranged to be connected.

44. The hydraulic actuator according to claim 42, wherein a second housing for the extension is arranged as an extension of the housing arranged for the tube spool, to which ducting, arranged for the ventilation, is arranged to be connected.

45. The hydraulic actuator according to claim 37, wherein the valve is arranged, in the case of one or more connections, to be a slide valve, in which a second housing is arranged as an extension of the housing arranged for the tube spool, in the area of which the access arranged to the tube spool for the inner cylinder part is arranged to be closed.

46. The hydraulic actuator according to claim 34, wherein the second ducting is arranged to form an operational part belonging to the valve, through which is arranged to be acted on the tube spool, arranged to move axially backwards and forwards, to control the pressure medium feed to create the work movement, alternately by means of the operating element of the inner or outer cylinder part.

47. The hydraulic actuator according to claims 46, wherein the second ducting is arranged to move with the tube spool axially backwards and forwards.

48. The hydraulic actuator according to claim 32, further comprising in the end of the second ducting a retainer element arranged to interact with the piston of the inner cylinder part and to stop the work movement of the hydraulic actuator.

49. The hydraulic actuator according to claim 48, wherein the retainer element is arranged to achieve at least one or both of the following:
to prevent mechanically the work movement of the inner cylinder part; and
to transmit, by means of the second ducting of the spool valve the force created by the piston of the inner cylinder part, to stop the work movement of the outer cylinder part.

50. The hydraulic actuator according to claim 32, further comprising a shutter in the housing to prevent access by the pressure medium the housing from the first ducting.

51. The hydraulic actuator according to claim 34, further comprising a loading element in the valve to act on the tube spool in the opposite direction to the one or several pressure surfaces arranged for the pressure medium acting on chamber of the inner cylinder part.

52. The hydraulic actuator according to claim 51, wherein the loading element acting on the tube spool is dimensioned relative to one or more effective pressure surfaces in such a way that
if a set pressure criterion is not met, the loading element is arranged to keep the pressure-medium connection open to chamber of the inner cylinder part and to close the pressure-medium connection to chamber of the outer cylinder part; and
if a set pressure criterion is exceeded, the force of the pressure-medium of chamber of the inner cylinder part acting on one or to several effective pressure surfaces is arranged to overcome the force created by the loading element and to open the pressure-medium connection to chamber of the outer cylinder part and to close the pressure-medium connection to chamber of the inner cylinder part.

53. The hydraulic actuator according to claim 32, wherein the valve comprises a cover, to which is fitted the first connection, arranged to close the housing from the side of chamber of the outer cylinder part.

54. A working device comprising:
a body;
one or more moving working elements fitted to the body; and
one or more hydraulic actuators according to claim 32 to move one or more working elements.

55. The working device according to claim 54, wherein the working device is an energy-wood grapple comprising:
a frame;
a cutting device fitted to the frame to cut a tree; and
a hydraulic actuator arranged to operate the cutting device, to which the moving working element belongs.

56. The working device according to claim 54, wherein the working device is a wood-chopping machine comprising:
a frame; and
a splitting device fitted to the frame to split wood, which comprises a blade and a hydraulic actuator arranged to split the wood using the blade.

57. An energy-wood grapple comprising:
a body;
a cutting device fitted to the body to cut a tree, which comprises a work element arranged to move; and
a hydraulic actuator according to claim 32 arranged to move the working element.
